(19) United States
(12) Patent Application Publication
(10) Pub. No.: US 2026/0043823 A1
(43) Pub. Date: Feb. 12, 2026

(54) CONTROL DEVICE

(71) Applicant: Endress+Hauser Conducta GmbH+Co. KG, Gerlingen (DE)

(72) Inventors: Hui Huang, Suzhou (CN); Wenbin Zhang, Suzhou (CN)

(21) Appl. No.: 19/291,139

(22) Filed: Aug. 5, 2025

(30) Foreign Application Priority Data
Aug. 9, 2024 (CN) 202411093246.8

(51) Int. Cl. G01N 35/10; G05D 7/06

(52) U.S. Cl. CPC G01N 35/1009; G05D 7/0617

(57) ABSTRACT

A control device for regulating, guiding, or controlling flow of a fluid includes: at least one inflow channel for introducing a fluid and including a first movable component capable of opening, closing, or partially blocking the inflow channel; a manifold with a horizontal channel for conveying the fluid, the manifold including at least one manifold inlet in communication with the horizontal channel, which is in communication with the inflow channel, wherein one end of the horizontal channel has a first manifold outlet for discharging the fluid, and the other end has a second manifold outlet for discharging the fluid; and a connector including two connector inlets for receiving the fluid from the first manifold outlet and the second manifold outlet via two connection channels, the connector including a connector outlet for discharging the received fluid out of the control device.

### CROSS-REFERENCE TO RELATED APPLICATION

The present application is related to and claims the priority benefit of China (CNIPA) Patent Application No. 202411093246.8, filed Aug. 9, 2024, the entire contents of which are incorporated herein by reference.

### TECHNICAL FIELD

The present disclosure relates to a control device for regulating, guiding, or controlling flow of a fluid, and in particular, a control device for controlling conveyance of different liquid samples to a liquid analysis device.

### BACKGROUND

Liquid analysis is a scientific technique for detecting and quantifying components in a liquid sample. It is of great significance in a variety of fields such as environmental protection, product quality control, process optimization, and safety monitoring. Liquid analysis includes analysis of liquids such as water, beverages, dairy products, chemicals, and pharmaceuticals.

A control device is often needed in a liquid analysis system to control liquid conveyance and may be specifically used for controlling parameters such as the direction, pressure, and flow rate of a liquid. The control device has functions such as cut-off, regulation, flow diversion, backflow prevention, pressure stabilization, flow splitting, or overflow pressure relief. An example of such a control device is a valve block. The valve block can be used to control different types of flows, such as flows of air, water, steam, various corrosive media, slurries, liquid metals, and radioactive liquids.

Use of a valve block, serving as a control device, is known in liquid analysis. In a liquid analysis service, a client sometimes needs to analyze several different liquid samples by using one liquid analysis device. These samples are fed into the analysis device from different regions.

In the prior art, a control device 1 (referring to FIG. 1) is used to convey different samples to the analysis device by means of different channels. The control device 1 is a multi-channel valve block and has the function of separating different samples from one another.

As shown in FIG. 1, the control device 1 is provided with six inflow channels 21, 22, 23, 24, 25, 26, each for introducing a different sample. Each of the inflow channels is provided with a first movable component 41, 42, 43, 44, 45, 46 capable of opening, closing, or partially blocking the inflow channel. In operation, once one of the inflow channels is used to complete sampling and analysis, another inflow channel will be used, and the measurement result is not affected by the sample in the previous sampling process.

Different samples sequentially pass through the different inflow channels, flow through a manifold 5 (additionally referring to FIG. 2) provided with a horizontal channel 50, and are then conveyed, by means of a manifold outlet 57, to a liquid analysis device (not shown) for analysis. The manifold 5 is provided with six manifold inlets 51, 52, 53, 54, 55, 56 in communication with the horizontal channel 50, and each manifold inlet is in communication with the corresponding one of the inflow channels 21, 22, 23, 24, 25, 26.

However, during the actual operation process, samples may be cross-contaminated, especially when passing through the manifold 5, and the impact thereof cannot be ignored. For example, after sampling and analysis of a first sample is completed, e.g., using the sixth inflow channel 26, sampling and analysis of a second sample may be performed, e.g., using the first inflow channel 21. In this case, residue of the first sample remains in the horizontal channel 50 between the first manifold inlet 51 and the sixth manifold inlet 56. Therefore, when the second sample flows through the manifold, the residue of the first sample in the manifold 5 may continuously cross-contaminate the second sample.

In addition, the samples typically contain suspended solids, and the analysis device may need to further assess the content of these solids in the samples. For example, during quantification of oxidizable pollutants (e.g., chemical oxygen demand (COD)) in surface water (e.g., lakes and rivers) or wastewater), it is sometimes necessary to assess the organic content in suspended solids. When these samples are conveyed to a liquid analyzer by means of the control device, the samples need to pass not only through the inflow channels, but also through the movable components located in the inflow channels. These components are usually valves in contact with the samples. However, suspended solids in a sample commonly block the inflow channel at the valve, which leads to high maintenance costs.

Therefore, a new device is needed to control flow of liquid samples such that cross-contamination is minimized, the new device also having the capability of treating suspended solids in the samples.

### SUMMARY

Thus, an object of the present disclosure is to provide a control device for regulating, guiding, or controlling flow of a liquid sample and a system for analyzing the liquid sample. The control device can reduce cross-contamination between different channels or different samples and has the capability of treating suspended solids in the samples.

According to the present disclosure, the control device includes at least one inflow channel for introducing a fluid; and a manifold, provided with a horizontal channel and used for conveying the fluid. The inflow channel is provided with a first movable component capable of opening, closing, or partially blocking the inflow channel. The manifold is provided with at least one manifold inlet in communication with the horizontal channel, wherein the manifold inlet is in communication with the inflow channel, and one end of the horizontal channel is provided with a first manifold outlet for discharging the fluid, and characterized in that the other end of the horizontal channel is provided with a second manifold outlet for discharging the fluid. The control device further includes a connector, which is provided with two connector inlets for receiving the fluid from the first manifold outlet and the second manifold outlet by means of two connection channels, and the connector is further provided with a connector outlet for discharging the received fluid out of the control device.

Due to the arrangement of the first manifold outlet and the second manifold outlet at the manifold, the fluid can be discharged from both ends of the horizontal channel, rather than from the manifold outlet at one end only. By using the control device to control entry of different fluids from different inflow channels, a fluid used in the previous analysis is not retained in the manifold, so that the cross-contamination between different fluids is greatly reduced.

The present disclosure provides detailed descriptions of other advantageous embodiments of the control device for regulating, guiding, or controlling flow of a fluid according to the present disclosure and further sets forth a system for analyzing a liquid sample by using the control device according to the present disclosure.

Although the embodiments of the present disclosure have been described in terms of controlling the flow of liquid samples, the present disclosure is also applicable to gases and other fluids.

### BRIEF DESCRIPTION OF THE DRAWINGS

The present disclosure will be further described below with reference to the accompanying drawings and embodiments, in which:

FIG. 1 shows the prior art;

FIG. 2 is a perspective view of a prior art manifold;

FIG. 3 is a schematic diagram of an embodiment of the present disclosure;

FIG. 4 is a perspective view of a manifold of the embodiment in FIG. 3; and

FIG. 5 is a schematic diagram of another embodiment of the present disclosure.

### DETAILED DESCRIPTION

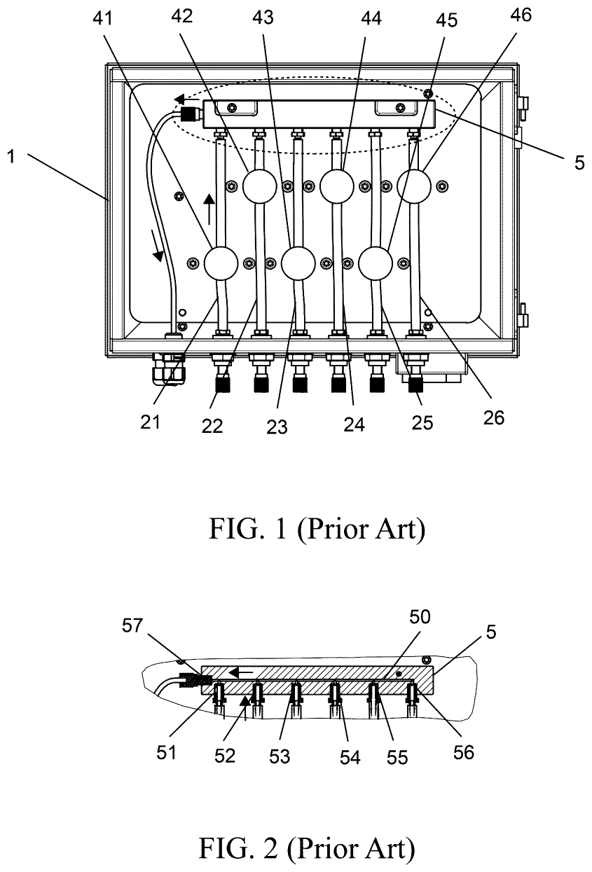

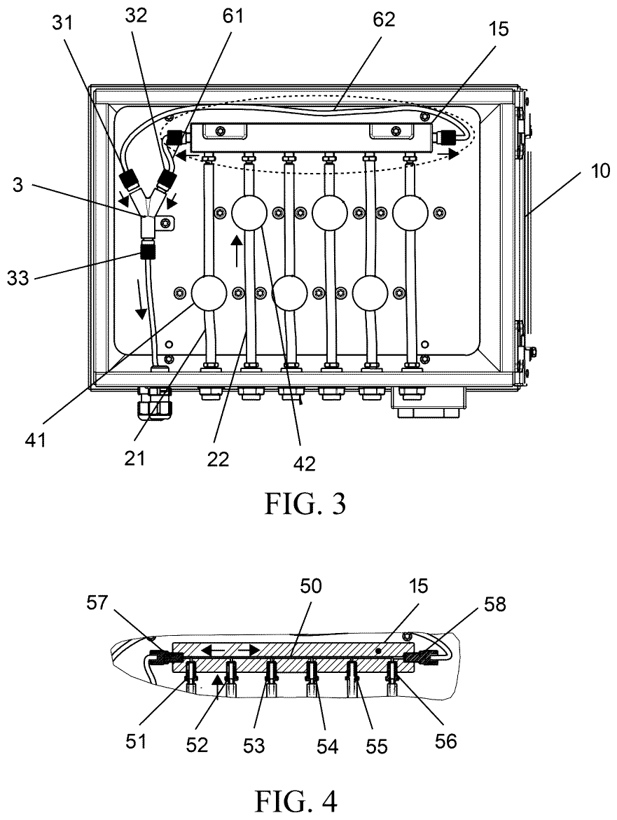

FIG. 3 illustrates an implementation of the present disclosure, and in particular, a control device 10 for liquid analysis, for example, a multi-channel valve block. A fluid to be regulated, guided, or controlled is a liquid sample, and in particular, wastewater in environmental chemistry. The liquid analysis device (not shown) may be an instrument for quantifying the chemical oxygen demand (COD) or the total organic carbon (TOC) in a sample. The control device 10 in FIG. 3 includes all the technical features of the prior art in FIG. 1 and FIG. 2, namely, six inflow channels 21, 22, 23, 24, 25, 26, six first movable components 41, 42, 43, 44, 45, 46, and a manifold. The inflow channels 21, 22, 23, 24, 25, 26 have the same diameter, each for introducing different samples. For example, when a client introduces a first sample by using the inflow channel 21, the first movable component 41 is opened and the other first movable components 42, 43, 44, 45, 46 are closed, so that the first sample can be introduced from the inflow channel 21 without being affected by the other inflow channels 22, 23, 24, 25, 26. Subsequently, when the client wants to sample and analyze a second sample, the client may choose to introduce the second sample from the channel 22. In this case, the first movable component 42 can be opened while the other first movable components 41, 43, 44, 45, 46 are kept closed.

The first movable components 41, 42, 43, 44, 45, 46 may not be in contact with the sample. Such an arrangement has the advantage that when there are suspended solids in the sample, the suspended solids do not block the inflow channels 21, 22, 23, 24, 25, 26 at the first movable components 41, 42, 43, 44, 45, 46. The first movable components 41, 42, 43, 44, 45, 46 may be pinch valves, and the inflow channels 21, 22, 23, 24, 25, 26 may be flexible tubes.

In addition, the control device 10 in FIG. 3 further includes a connector 3. The connector 3 is provided with two connector inlets 31, 32 and one connector outlet 33. The connector 3 may be a Y-type connector. The connector 3 functions to gather samples flowing from a manifold 15.

FIG. 4 is a perspective view of the manifold 15 of the embodiment in FIG. 3. The manifold 15 includes a horizontal channel 50, two ends of which are respectively provided with a first manifold outlet 57 and a second manifold outlet 58. The manifold 15 may be provided with six manifold inlets 51, 52, 53, 54, 55, 56, all of which are in communication with the horizontal channel 50. Each manifold inlet is in communication with the corresponding one of the inflow channels 21, 22, 23, 24, 25, 26. The horizontal channel 50 functions to convey samples, and different samples may be conveyed by means of the horizontal channel 50. Unlike the prior art in FIG. 1 and FIG. 2, the samples flow out of the manifold 15 by means of the first manifold outlet 57 and the second manifold outlet 58, respectively, after reaching the horizontal channel 50, rather than flowing out of the manifold 15 by means of only the first manifold outlet 57. In this way, during each sampling, the sample remaining in the horizontal channel 50 after the previous sampling is carried out of the manifold 15 by a new sample, thereby preventing the previous sample from remaining in the manifold 15 and cross-contaminating the new sample.

The diameters of the horizontal channel 50, the first manifold outlet 57, the second manifold outlet 58, and the manifold inlets 51, 52, 53, 54, 55, 56 of the manifold 15, and the diameters of the connector inlets 31, 32 and the connector outlet 33 of the connector 3 are all the same, and all are smaller than the diameters of the inflow channels 21, 22, 23, 24, 25, 26.

After passing through the manifold 15, the sample is converged into the connector 3 by means of the two connection channels 61, 62 and then is discharged out of the control device 10 by means of the connector outlet 33.

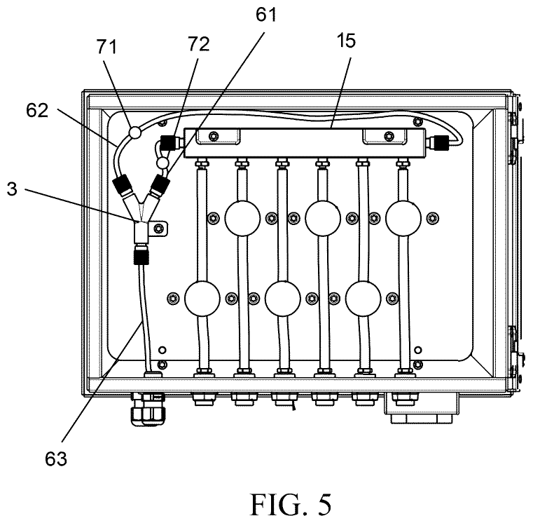

FIG. 5 is a schematic diagram of another embodiment of the present disclosure, including all the technical features of the embodiment in FIG. 3, and additionally including two second movable components 71, 72. The second movable components 71, 72 are respectively arranged at the connection channels 61, 62, and are capable of opening, closing, or partially blocking the connection channels 61, 62.

In actual operation, the sample flowing into the manifold 15 may not flow out equally from the first manifold outlet 57 and the second manifold outlet 58, for example by 50% each ; instead, it is more likely that more sample flows out from the first manifold outlet 57 and less sample flows out from the second manifold outlet 58. The arrangement of the second movable components 71, 72 may regulate the flow rates and the flow volumes of the sample at the first manifold outlet 57 and the second manifold outlet 58.

The second movable components 71, 72 may not be in contact with the sample. Such an arrangement has the advantage that when there are suspended solids in the sample, the suspended solids do not easily block the connection channels 61, 62 at the second movable components 71, 72. The second movable components 71, 72 may be pinch valves, and the connection channels 61, 62 may be flexible tubes.

The present disclosure further includes a system for analyzing a liquid sample, including the control device 10 and a liquid analysis device (not shown), for example, an analyzer for analyzing the chemical oxygen demand (COD) or the total organic carbon (TOC) of a liquid. This system is used for analysis of a liquid sample, and in particular, different liquids. The liquid analysis device is provided with an analysis device inlet (not shown) for receiving the sample from the connector outlet 33 (referring to FIG. 3) by means of an outflow channel 63 (referring to FIG. 5). The liquid analysis device includes a pump, which is used for conveying a sample from the outside of the system to the control device 10, forcing the sample to flow through the outflow channel 63, and then conveying same to the analysis device for analysis.

Claimed is:

1. A control device for regulating, guiding, or controlling flow of a fluid, the control device comprising:
at least one inflow channel for introducing a fluid and including a first movable component capable of opening, closing, or partially blocking the at least one inflow channel;
a manifold including a horizontal channel configured to convey the fluid and at least one manifold inlet in communication with the horizontal channel and with a corresponding inflow channel of the at least one inflow channel,
wherein one end of the horizontal channel includes a first manifold outlet for discharging the fluid, and the other end of the horizontal channel includes a second manifold outlet for discharging the fluid; and
a connector including two connector inlets for receiving the fluid from the first manifold outlet and the second manifold outlet, respectively, via two connection channels and including a connector outlet for discharging the received fluid from the control device.

2. The control device according to claim 1, wherein the at least one inflow channel includes at least two inflow channels for introducing different fluids.

3. The control device according to claim 1, wherein the first movable component is not in contact with the fluid.

4. The control device according to claim 3, wherein the first movable component is a pinch valve, and the at least one inflow channel is a flexible tube.

5. The control device according to claim 1, wherein the connector is a Y-shaped connector.

6. The control device according to claim 1, wherein each connection channel includes a second movable component capable of opening, closing, or partially blocking the connection channel.

7. The control device according to claim 6, wherein each second movable component is not in contact with the fluid.

8. The control device according to claim 7, wherein each second movable component is a pinch valve, and each connection channel is a flexible tube.

9. A system for analyzing a liquid sample, the system comprising:
the control device according to claim 1; and
a liquid analysis device comprising:
an analysis device inlet for receiving the liquid sample from the connector outlet via an outflow channel; and
a pump configured to force the liquid sample to flow through the outflow channel,
wherein the fluid is a liquid sample.
